(19) United States
(12) Patent Application Publication
(10) Pub. No.: US 2014/0280930 A1
(43) Pub. Date: Sep. 18, 2014

(54) Biometric Recognition Based Session Matching and Routing

(71) Applicant: FUTUREWEI TECHNOLOGIES, INC., Plano, TX (US)

(72) Inventor: Ian Foo, Raleigh, NC (US)

(73) Assignee: FUTUREWEI TECHNOLOGIES, INC., Plano, TX (US)

(21) Appl. No.: 13/799,929

(22) Filed: Mar. 13, 2013

(51) Int. Cl. H04L 29/08

(52) U.S. Cl. CPC H04L 67/14
USPC 709/225

(57) ABSTRACT

An apparatus comprising a processor configured to obtain user biometric recognition data from a first user device, map the user biometric recognition data to an identity, correlate the identity with an active user session previously associated with a second user device, associate the active user session with the first user device, and instruct the first user device to continue the active user session on the first user device.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

End-user session technology is rapidly evolving. With the advent of remote storage (e.g. the cloud), faster data throughput and inexpensive local mass storage, end-user applications such as NETFLIX, HULU, AMAZON and other real-time streaming video suppliers support playback on many user devices. The growth of the industry leads to an average user owning and/or operating multiple user devices. Technology provides a user with opportunities to access end-user sessions through applications on televisions, phones, tablets, laptops, desktop computers, gaming consoles and other user devices. Additionally, evolving technology allows users to access user devices using integrated biometric sensors such as user facing cameras, voice recognition and fingerprint analysis.

Currently, if a user wishes to move a session from one user device to another, the user manually opens the application associated with the session on the next user device and manually continues the session. Technology in some applications, such as NETFLIX, tracks the previous status of a session. For example, if the user watches a movie on a television then manually opens NETFLIX on a tablet and starts the movie, the movie begins where it paused on the television. However, this manual process provides no continuity. A user halts progress in a movie or in a video conference if the user wishes to move to a new user device.

### SUMMARY

In one embodiment, the disclosure includes an apparatus comprising a processor configured to obtain user biometric recognition data from a first user device, map the user biometric recognition data to an identity, correlate the identity with an active user session previously associated with a second user device, associate the active user session with the first user device, and instruct the first user device to continue the active user session on the first user device.

In another embodiment, the disclosure includes an apparatus comprising a processor configured to detect a user operating a user device, obtain user biometric recognition data, send the user biometric recognition data to a remote storage device, and continue an active user session on the user device previously associated with a second user device.

In yet another embodiment, the disclosure includes a method for performing biometric recognition based session routing and continuity, the method comprising detecting a user operating a first user device, obtaining user biometric recognition data, sending the user biometric recognition data to a remote storage device, mapping the user biometric recognition data to an identity, correlating the identity with an active user session previously associated with a second user device, associating the active user session with the first user device, and routing the active user session to the first user device.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a system that performs biometric recognition based session routing and continuity.

FIG. 2 is a flowchart of an embodiment of a method of performing biometric recognition based session routing and continuity.

FIG. 3 is a flowchart of an embodiment of a method of performing biometric recognition based session routing and continuity.

FIG. 4 is a schematic diagram of an embodiment of a user device.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a method and system to perform biometric recognition based session routing and continuity for a user. A remote storage device may route an active user session to a first user device. The remote storage device may obtain biometric (e.g. facial recognition, fingerprint, etc.) information for the user, and may track user progression through the user session. The user may stop the user session on the first user device, and may subsequently interface with a second user device. The second user device may detect the user via the biometric information and notify the remote storage device. The remote storage device associates the active user session with the second user device. The second user device may then prompt the user to continue the active user session on the second user device.

FIG. 1 is a schematic diagram of an embodiment of a system 100 that performs biometric recognition based session routing and continuity for a user session. The system 100 may comprise a plurality of storage devices 105 in a cloud 110, a plurality of local connectivity devices 120, and a plurality of user devices 122. As shown in FIG. 1 the user devices 122 may be coupled to the local connectivity devices 120, and the local connectivity devices 120 may be coupled to the cloud 110. The system 100 is configured to route user sessions from the cloud 110 to the user devices 122 via the local connectivity devices 120. Each of these components is described in further detail below.

The cloud 110 may be any network, device, or combination of devices configured to provide a user session to a user device 122. The cloud 110 may comprise a plurality of storage devices 105 that store content requested by users and or biometric profiles for various users. The cloud 110 may comprise a plurality of routers, servers, bridges, switches, and combinations of such devices that provide connectivity between the storage devices 105 and the local connectivity devices 120.

A user session may be a set of information that may describe a user's operation of a plurality of applications on a user device. The set of information may comprise a plurality of application data, settings, history, preferences, identification information and/or other information associated with the operation of an application on a user device. Applications may include embedded streaming videos, webcasts, podcasts, Internet Protocol television, video conferencing, video messaging, and/or other end-user sessions.

User biometric recognition data may comprise raw data, such as an image of a user from a front facing camera, or a set of data derived from the raw data. Persons of ordinary skill in the art are aware of a number of methods that may be used to obtain user biometric recognition data. Some of those methods may be to use an integrated front facing camera to capture an image of the user, capture a voice clip of the user or have the user slide their finger across a finger pad. Biometric recognition data is an evolving technology and continues to progress in the ways user devices support biometric recognition sensors and methods.

The local connectivity devices 120 each may be any device or combination of devices configured to provide connectivity between the cloud 110 and the user devices 122. The local connectivity devices 120 may include one or more wired (e.g. electrical or optical) networks and/or wireless networks, for example the Internet. The local connectivity device 120 and the cloud 110 may be coupled to a plurality of user devices 122.

The user device 122 may comprise a variety of devices, such as personal computers, cellular phones, tablets, laptops, televisions, gaming consoles, and/or other devices with integrated biometric sensors. FIG. 4 provides one embodiment of a schematic diagram of a user device 122. The active user sessions may be routed through the local connectivity device 120 or through a virtual storage device in the cloud 110. The active user session may be routed to a user device 122 from a previously associated user device 122. The active user session may be routed once a user is detected at a user device 122. A user may be detected using integrated biometric sensors on the user device 122. The user device 122 may access an active user session of an internal application (e.g. NETFLIX) through the Internet.

FIG. 2 is a flowchart of an embodiment of a method 200 of performing biometric recognition based session routing and continuity. Method 200 may be implemented on a remote storage device (e.g. within the cloud). Method 200 may start at block 210 by obtaining a message from a user device. The message may comprise status of an active user session or user biometric recognition data. Block 220 may differentiate between the two types of messages. In one embodiment of method 200, the user biometric recognition data may be converted to a common format. In another embodiment, the user biometric recognition data may be received in a device vendor specific format.

If the message from the user device is an update of an active user session, the method 200 may proceed to block 222 where the identity of the user may be accessed. Block 224 may determine if the user device originating the message is not the active user device. If the user device is not the active user device, then block 226 may associate the active user session with the new user device and may proceed to block 228 where the status of the active user session may be updated. If the user device is the current user device, then the status of the active user session may be updated at block 228. The process may end at block 240.

If at block 220 the message from the user device contains user biometric recognition data, then method 200 may proceed to block 230 where the user biometric recognition data may be mapped to an identity. Block 232 may then correlate the identity with an active user session. Block 234 may determine if the user device originating the message is the current user device associated with the active user session. If the user device is the current user device, block 238 instructs the user device to continue the active user session. Block 234 may determine that the user device is a new user device. Method 200 may then associate the active user session with the new user device at block 236. At this point, method 200 may proceed to block 238 and instruct the new user device to continue the active user session. After block 238, method 200 proceeds to end block 240 and is complete. Method 200 may wait to obtain a new message from the user device, at which point method 200 may begin at block 210.

FIG. 3 is a flowchart of an embodiment of a method 300 of performing biometric recognition based session routing and continuity. Method 300 may begin by waiting for a user to be detected by a biometric sensor in block 310. There are many ways to wait for user detection in block 310. In one embodiment of block 310 the user device may wait an amount of time to reattempt detection of the user. In another embodiment of block 310, the user device may wait for a significant change in the device integrated biometric sensor to reattempt detection of the user. In yet another embodiment, the user device may wait for an event initiated by the user.

Block 312 may check to see if a user is detected. If a user is not detected the user device may return to block 310 to wait for activation from an integrated biometric sensor. If the user is detected then method 300 may proceed to block 314. At block 314, user biometric recognition data may be obtained.

After obtaining user biometric data at block 314, the user biometric data may be sent to a remote storage device in block 316. In one embodiment of block 316, the user device may send the raw data captured by the biometric sensor in the device vendor specific format. In another embodiment of block 316, the user device may send a set of data derived from the raw data captured by the biometric sensor. In yet another embodiment, the data sent to the remote storage device may be converted from a device vendor specific format into a common format read by the remote storage device.

In block 318, the current status of active user sessions may be returned from the remote storage device. Block 320 may verify that an application for the active user session is present on the user device. If not already installed, the application for the active user session may be installed at block 320, e.g. from an application store on the Internet. Block 322 makes a decision based on the presence of the application. If an application is not present, then block 324 may return a message to the remote storage device that there is no change in the status of the active user session. Alternatively, the user device can install the application and return to block 322. If the application is present on the user device, then method 300 proceeds to block 326. Block 326 may prompt the user on a display with a decision to continue the active user session. If the user does not wish to continue the active user session block 324 may return a message to the remote storage device that there is no change in the status of the active user session. If the user wishes to continue the active user session at block 326, then method 300 may proceed to block 328 where the application for the active user session may be opened and the active user session may continue from its current state. Block 330 updates the remote storage device with current status of the active user session. In another embodiment of method 300, block 326 does not exist and method 300 may proceed directly from block 322 to block 328 to open the application and continue the active user session (e.g. automatically launch the active user session). After block 324 or 330 updates the remote storage device, the method 300 may return to block 310 to await activation by a user biometric sensor.

FIG. 4 is a schematic diagram of an embodiment of a user device 400. A user device 400 may have voice and data communication capabilities. The user device 400 generally has the ability to communicate with other computer systems on the Internet. Depending on the exact functionality provided, user device 400 may comprise a user device as in FIG. 1.

The user device 400 may comprise a processor 410 (which may referred to as a central processor unit or CPU) that is in communication with memory devices including random access memory/volatile storage (RAM) 460, read only memory/non-volatile storage (ROM) 464, and external storage 462. The processor 410 may be implemented as one or more CPU chips, one or more cores (e.g., a multi-core processor), or may be part of one or more application specific integrated circuits (ASICs) and/or digital signal processors (DSPs). The processor 410 may be configured to implement any of the schemes described herein, and may be implemented using hardware, software, firmware, or combinations thereof.

The external storage 462 may be comprised of one or more solid state drives, disk drives, and/or other memory types and are used for non-volatile storage of data and as an over-flow data storage device if RAM 460 is not large enough to hold all working data. External storage 462 may be used to store programs (e.g., applications) that are loaded into RAM 460 when such programs are selected for execution. The ROM 464 may be used to store instructions and perhaps data that are read during program execution. Rom 464 may be a non-volatile memory device and may have a small memory capacity relative to the larger memory capacity of external storage 462. The RAM 460 may be used to store volatile data and perhaps to store instructions. Access to both ROM 464 and RAM 460 may be faster than to external storage 462.

The user device 400 may communicate data (e.g., packets) wirelessly with a network through a radio 422 that may be coupled to an antenna 420. In another embodiment of user device 400 the antenna 420 may be replaced with a wired connection. The user device 400 may also comprise a display device 450 coupled to the processor 410, that displays output thereof to a user. The user device 400 and the display device 450 may be configured to display representations of data to a user. The display device 450 may display in color or monochrome and may be equipped with a touch sensor based resistive and/or capacitive technologies.

The user device may further comprise an input device 440 coupled to the processor 410, which may allow the user to input commands to the user device 400. In the case that the display device 450 comprises a touch sensor, the display device 450 may also be considered the input device 440. In addition to and/or in the alternative, an input device 440 may comprise a mouse, trackball, built-in keyboard, external keyboard, television remote control, gaming console controller, and/or any other device that a user may employ to interact with a user device 400.

The user device may even further comprise a camera 432. The camera 432 may comprise an internal camera, or an external camera. The camera 432 may be mounted facing the user. The user device may comprise biometric sensors 430. In the case that the camera 432 may be mounted facing the user, the camera 432 may also be considered as a biometric sensor 430.

The described method and system to perform biometric recognition based session routing and continuity for a user is faster and more convenient than manual transitions between user devices. Advantages such as, but not limited to, continuing conference calls, movies and other end user sessions without interruption make multiple user device use easier for the user in a world of evolving technology.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 5, 4, etc.; greater than 0.10 includes 0.11, 0.12, 0.15, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 5 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a processor configured to:
obtain user biometric recognition data from a first user device;
map the user biometric recognition data to an identity;
correlate the identity with an active user session previously associated with a second user device;
associate the active user session with the first user device;
instruct the first user device to continue the active user session on the first user device.

2. The apparatus in claim 1, wherein a multitude of active user sessions previously associated with a second user device are associated with the first user device.

3. The apparatus in claim 1, wherein the processor is located on a remote storage device in a cloud computing system.

4. The apparatus in claim 1, wherein the processor maintains a current status of the active user session.

5. An apparatus comprising:
a processor configured to:
detect a user operating a user device;
obtain user biometric recognition data;
send the user biometric recognition data to a remote storage device;
continue an active user session on the user device previously associated with a second user device.

6. The apparatus of claim 5, wherein the user is detected by a device integrated biometric sensor.

7. The apparatus of 6, wherein the processor is further configured to wait for the user to be detected.

8. The apparatus of claim 7, wherein the processor is further configured to wait an amount of time to reattempt detection of the user.

9. The apparatus of claim 7, wherein the processor is further configured to wait for a significant change in the device integrated biometric sensor to reattempt detection of the user.

10. The apparatus of claim 7, wherein the processor is further configured to wait for an event initiated by the user.

11. The apparatus of claim 5, wherein the processor is further configured to receive the active user session previously associated with a second user device from the remote storage device.

12. The apparatus of claim 11, wherein the processor is further configured to verify that an application for the active user session is present on the user device.

13. The apparatus of claim 12, wherein the processor is further configured to notify the remote storage device that the application for the active user session is not present on the user device.

14. The apparatus of claim 12, wherein the processor is further configured to install the application that was not previously present on the user device.

15. The apparatus of claim 5, wherein the user is prompted with a decision to continue the active user session on the user device.

16. A method for performing biometric recognition based session routing and continuity, the method comprising:
detecting a user operating a first user device;
obtaining user biometric recognition data;
sending the user biometric recognition data to a remote storage device;
mapping the user biometric recognition data to an identity;
correlating the identity with an active user session previously associated with a second user device;
associating the active user session with the first user device;
routing the active user session to the first user device.

17. The method of claim 16, wherein the user is prompted with a decision to continue or end the active user session.

18. The method of claim 16, wherein the remote storage device maintains a current status for the active user session.

19. The method of claim 16, wherein an application for the active user session, previously not present on the first user device, is installed on the first user device.

20. The method of claim 19, wherein the active user session is routed to the first user device after the application for the active user session is installed.
